(19) United States
(12) Patent Application Publication
(10) Pub. No.: US 2026/0274442 A1
(43) Pub. Date: Sep. 17, 2026

(54) METHOD FOR INSPECTING AN AIRCRAFT COMPONENT

(71) Applicant: Airbus SAS, BLAGNAC (FR)

(72) Inventors: Tejas Shriprakash TADPATRIKAR, FILTON (GB); Sagnik CHAKRABORTY, FILTON (GB); Anurag BANSAL, FILTON (GB)

(21) Appl. No.: 19/559,072

(22) Filed: Mar. 6, 2026

(30) Foreign Application Priority Data
Mar. 13, 2025 (IN) 202511022601

(51) Int. Cl. B64F 5/60; G06T 7/00

(52) U.S. Cl. CPC B64F 5/60; G06T 7/001; G06T 2207/30252

(57) ABSTRACT

An apparatus for use in a testing procedure on an object, the apparatus comprising one or more processors configured to: receive an image of the object; obtain a reference image associated with the object, the reference image including a representation of the object divided into a plurality of zones, each zone being associated with a respective testing action of the testing procedure; simultaneously output the received image and the reference image on a display unit; receive an input indicative of a first testing action associated with a first zone being completed; and output, on the display unit, a first indication that the first testing action has been completed for the first zone.

### CROSS-REFERENCES TO RELATED APPLICATIONS

This application claims the benefit of Indian Patent Application Number 202511022601 filed on Mar. 13, 2025, the entire disclosure of which is incorporated herein by way of reference.

### FIELD OF THE INVENTION

The present invention relates to a method and apparatus for inspecting an aircraft component.

### BACKGROUND OF THE INVENTION

Non-Destructive Testing (often referred to as “NDT”) is widely used throughout the aerospace industry for inspecting aircraft components.

When performing an NDT inspection on an aircraft component, an operator will typically follow a pre-approved inspection procedure (or “Scan Plan”) which corresponds to the particular aircraft component undergoing the inspection.

Notably, the pre-approved inspection procedure will typically set out the particular areas of the aircraft component which must be inspected and also the particular NDT techniques and methods which should be utilized when inspecting particular areas of the aircraft component.

Given the large number of components present on a particular aircraft, it is unrealistic for an inspector to be expected to properly memorize the particular “Scan Plans” which must be followed for each in-service component.

Therefore, to help address this issue, the aforementioned inspection procedures (or “Scan Plans”) are often provided on physical “technique cards” which must be obtained by the inspector and studied thoroughly prior to each inspection.

However, it shall be appreciated that obtaining and studying such “technique cards” prior to each inspection is a very time-consuming process and hence may adversely impact inspection throughput and inspector productivity.

Furthermore, it is also possible that during the inspection of a given component, the operator may mis-remember or accidentally omit certain aspects of the inspection procedure which may then require the (or another) inspector to re-inspect the aircraft component thereby further increasing the time-burden of the inspection process.

It is therefore an aim of the present invention to address one or more of the aforementioned disadvantages associated with known NDT inspection procedures.

### SUMMARY OF THE INVENTION

A first aspect of the invention provides an apparatus for use in a testing procedure on an object, the apparatus comprising one or more processors configured to: receive an image of the object; obtain a reference image associated with the object, the reference image including a representation of the object divided into a plurality of zones, each zone being associated with a respective testing action of the testing procedure; simultaneously output the received image and the reference image on a display unit; receive an input indicative of a first testing action associated with a first zone being completed; and output, on the display unit, a first indication that the first testing action has been completed for the first zone.

Advantageously, a user performing the testing procedure on the object is effectively informed as to the progress of the testing procedure. The apparatus provides the user with information guiding their performance of the testing procedure, and in particular informs the user as to whether testing actions have been completed for each zone (and consequently, whether any testing actions remain outstanding).

In some examples, the one or more processors are further configured to output, on the display unit, a second indication indicative of a respective second testing procedure not being completed for a second zone. Thus, the user can readily identify which zones still require testing, thus ensuring that no zones are missed.

In some examples, the first indication and the second indication are graphically different. Thus, the user can quickly and easily identify the difference between zones which have been tested and zones which haven't yet been tested, without needing to consult detailed technical instructions.

In some examples, the first indication comprises coloring the first zone in a first color and the second indication comprising coloring the second zone in a second color.

In some examples, the first indication is displayed on the reference image. Thus, advantageously the display of the reference image is updated to reflect the performance of the testing procedure in the real world.

In some examples, the one or more processors are further configured to: receive a further input identifying an area of the object requiring re-inspection; and output, on the display unit, a user interface element indicating the area requiring re-inspection in the reference image. In this way, a user can quickly and easily record that an area requires further inspection. The area flagged by the user may correspond to a potential defect in the object, and for example may have been identified as suspicious by scanning equipment used by the user.

In some examples, the reference image is a scan plan comprising instructions for testing each zone of the object. Thereby, as well as being able to easily identify the status of the testing procedure, the user can readily understand which testing actions are required for each zone.

In some examples, the instructions for testing each zone of the object comprise a scanning technique to be used to test each zone of the object.

In some examples, the one or more processors are further configured to overlay the reference image over the received image. In this way, the user can easily relate the zones of the object shown in the reference image to the object in the real world, which thereby assists the user in performing the testing procedure. It should be understood that objects can have complex shapes and multiple zones, and that testing procedures can as such be complex. The apparatus therefore provides effective assistance to the user in performing the testing procedure.

In some examples, the one or more processors are further configured to align the reference image over the received image using image processing. When the images are aligned, the user can more quickly and easily relate zones of the reference image to parts of the real object. As such, the user is effectively assisted in performing the testing procedure.

In some examples, the one or more processors are further configured to align the reference image over the received image using image processing. Thus, user input to align the reference image and the received image is reduced. It should be understood that various forms of image processing may be used to align the images, including feature recognition, edge recognition, the use of identifiers or reference points, and other image processing techniques.

In some examples, the one or more processors are further configured to obtain the reference image from a memory of the apparatus or an external server storing a plurality of reference images associated with a respective plurality of objects.

In some examples, the one or more processors are further configured to obtain the reference image based on one or more of: a user input selecting the reference image from the plurality of stored reference images; an identifier of the object detected in the received image; or object recognition of the object in the received image. Thereby, user input in selecting the reference image is reduced.

In some examples, the reference image comprises one or more 2D images of the object or 3D images of the object. An appropriate image type can be selected by the user or based on the type of the object. For example, a 3D image may be helpful for the user when testing a complex object, while a 2D image may be sufficient for a substantially planar object while reducing processing overheads.

In some examples, the apparatus is communicatively coupled to an imaging device configured to capture the image of the object; and the received image of the object is received from the imaging device. Thus, the user can capture the image of the object and relate it to the reference image.

In some examples, the object is an aircraft component.

In some examples, the apparatus comprises a virtual reality, VR, or augmented reality, AR, wearable device. Advantageously, the use of a VR or AR wearable device means that the user does not need to turn away from the object or a scanning device when testing the object to consult separate testing instructions, as the reference image is displayed on the wearable device.

In some examples, the first zone of the object partially overlaps with a second zone of the object, and optionally wherein the first zone overlaps with the second zone by a distance of at least 5 mm. The overlap of adjacent zones may be predetermined and specified by the reference image. The overlap may be provided to ensure that the object is fully scanned.

In some examples, the one or more processors are further configured to generate a report to certify that all of the testing actions for the respective zones of the object have been completed, and that the testing procedure has been completed. Accordingly, the apparatus is able to provide an authenticated record of the testing procedure being completed.

In some examples, the testing action comprises a non-destructive inspection technique. In some examples, the non-destructive inspection technique is an ultrasonic inspection technique. In some examples, the non-destructive inspection technique is an ultrasonic A-scan inspection technique and/or an ultrasonic C-scan inspection technique.

A further aspect of the invention provides a system comprising the apparatus of any preceding claim and an imaging device configured to capture the image of the object.

A further aspect of the invention provides a method for performing a testing procedure on an object, the method comprising: receiving an image of the object; obtaining a reference image associated with the object, the reference image including a representation of the object divided into a plurality of zones, each zone being associated with a respective testing action of the testing procedure; simultaneously outputting the received image and the reference image on a display unit; receiving an input indicative of a first testing action associated with a first zone being completed; and outputting, on the display unit, a first indication that the testing action has been completed for the first zone.

A further aspect of the invention provides a method for inspecting an aircraft component comprising the steps of: identifying an aircraft component to be inspected, retrieving an inspection plan corresponding to the identified aircraft component from a plurality of inspection plans, wherein each inspection plan is associated with a corresponding aircraft component, and wherein each inspection plan comprises one or more inspection actions to be performed on the respective associated aircraft component, capturing an image of the aircraft component to be inspected, displaying the captured image of the aircraft component on a display unit, wherein the inspection plan is overlaid onto the captured image, receiving an input indicative of one or more regions of the aircraft component having been inspected in accordance with the inspection plan displayed on the display unit and updating the display of the captured image or the inspection plan in response to the received input.

### BRIEF DESCRIPTION OF THE DRAWINGS

Embodiments of the invention will now be described with reference to the accompanying drawings, in which:

FIG. 1 shows a schematic plan view of an aircraft;

FIG. 2 shows a perspective view of an aircraft component;

FIG. 3A shows a schematic side view of a non-destructive testing apparatus for inspecting the aircraft component illustrated in FIG. 2;

FIG. 3B shows another schematic side view of a non-destructive testing apparatus for inspecting the aircraft component illustrated in FIG. 2;

FIG. 4 shows a block diagram illustrating an apparatus for performing a testing procedure on an object;

FIG. 5 shows a block diagram illustrating a system for performing a testing procedure on an object;

FIG. 6 illustrates a user interface displayed during a testing procedure;

FIG. 7 illustrates a user interface displayed during a testing procedure;

FIG. 8 illustrates a user interface displayed during a testing procedure;

FIG. 9 illustrates a user interface displayed during a testing procedure;

FIG. 10 illustrates user interfaces displayed during a testing procedure; and

FIG. 11 shows a flow chart illustrating a method for performing a testing procedure.

### DETAILED DESCRIPTION OF THE PREFERRED EMBODIMENTS

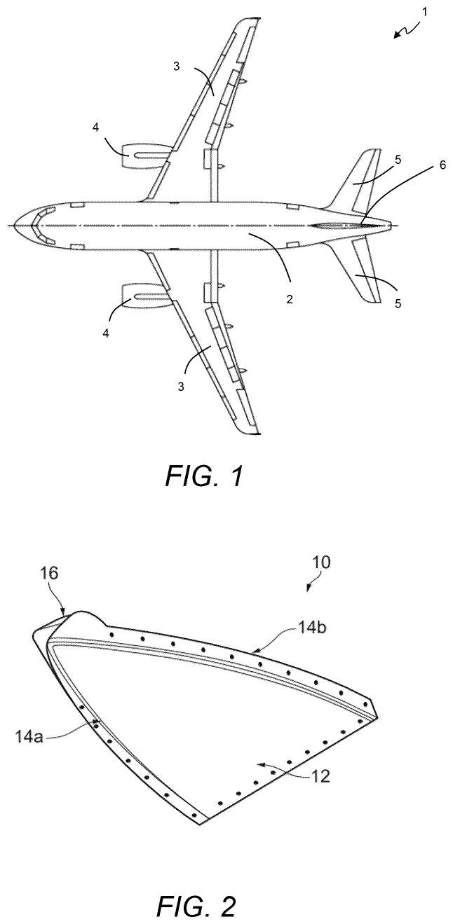

FIG. 1 shows an aircraft 1. The aircraft 1 has a fuselage 2, and starboard and port fixed wings 3. An engine 4 is mounted to each wing 3. The aircraft 1 also comprises an empennage (or tail assembly) which includes starboard and port horizontal stabilizers 5 and a vertical stabilizer 6.

In the embodiment illustrated in FIG. 1, the aircraft 1 is a typical jet passenger transport aircraft but the invention is applicable to a wide variety of fixed wing aircraft types, including commercial, military, passenger, cargo, jet, propeller, general aviation, etc., with any number of engines 4 attached to the wings 3 or fuselage 2.

The fuselage 2, wings 3, engines 4 and empennage of the aircraft 1 are each made up of a plurality of aircraft components 10 which must be routinely inspected at various points throughout the service life of the aircraft 1.

An example of one such aircraft component 10 is shown in FIG. 2.

In the illustrated embodiment, the aircraft component 10 is a fairing component which forms part of the aircraft “flap track” fairing. However, it shall be appreciated that in other embodiments, the aircraft component 10 may be of a different type.

As shown in FIG. 2, the aircraft component 10 comprises a planar web which forms a bottom surface 12 of the aircraft component 10 and a pair of flanges 14a, 14b which extend along opposing peripheral edges of the planar web 12.

In the illustrated embodiment, the opposing peripheral edges of the planar web 12 converge at one end of the aircraft component 10 to define a nose portion 16.

However, it shall be appreciated that in other embodiments, the aircraft component 10 may have a different shape.

In some embodiments, the aircraft component 10 may be formed of a metallic material. For example, the aircraft component 10 may be formed of aluminum, magnesium, titanium and/or steel.

In other embodiments, the aircraft component 10 may be formed of a composite material. For example, the aircraft component 10 may be formed of a carbon-fiber reinforced polymer (or CFRP) or may be formed of a glass-fiber reinforced polymer (GFRP).

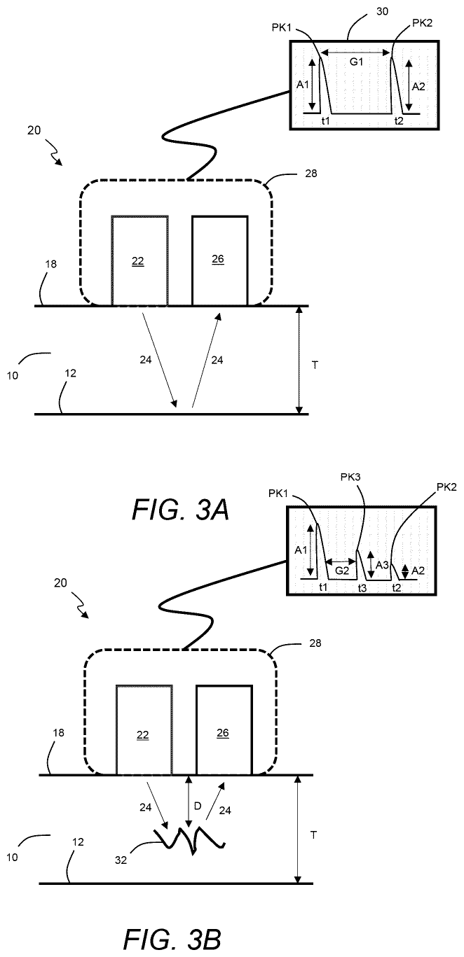

Referring now to FIG. 3, it shall be appreciated that the aircraft component 10 will typically require inspection during a “quality control process” prior to said component 10 being installed onto the aircraft 1 and also at various points throughout the service life of the aircraft component 10. For example, the aircraft component 10 may require inspection after a pre-determined number of flight hours have elapsed and/or after a pre-determined distance has been travelled by the aircraft 1 onto which the aircraft component 10 has been installed.

The inspection of such aircraft components 10 is often performed using Non-Destructive Testing (or NDT) techniques including, but not limited to, ultrasonic (UT) inspection, X-ray inspection, radiographic inspection; eddy current inspection, magnetic particle inspection, visual inspection and/or liquid penetrant inspection.

The term “Non-Destructive Testing” is defined herein as a method of determining one or more properties of a material and/or component without causing damage to (or otherwise adversely affecting the integrity of) the material and/or component being subjected to the testing procedure.

FIGS. 3A and 3B show a schematic illustration of a non-destructive testing apparatus 20 suitable for inspecting the aircraft component 10 illustrated in FIG. 2.

In the illustrated embodiment, the non-destructive testing apparatus 20 is an ultrasonic testing apparatus. However, it shall be appreciated that in other embodiments, the non-destructive testing apparatus 20 may be of a different type. For example, in some embodiments, the non-destructive testing apparatus 20 may be an X-ray testing apparatus.

As shown in FIGS. 3A and 3B, the non-destructive testing apparatus 20 comprises a source 22 which is configured to emit a pulse 24 of ultrasonic energy towards the aircraft component 10 and a corresponding transducer 26 which is configured to detect the pulse 24 of ultrasonic energy as it reflects (or echoes) back off one or more features of the aircraft component 10.

It shall be appreciated that the source 22 and the associated transducer 26 may be provided as separate components or as shown in FIG. 3, may be incorporated into a single probe 28.

Referring firstly to FIG. 3A, ultrasonic inspection is performed via placing the source 22 onto a surface (in this case a top surface 18) of the aircraft component 10 and emitting an pulse 24 of ultrasonic energy towards the aircraft component 10 such that the pulse 24 of ultrasonic energy can propagate through the material of the component 10.

In the case of FIG. 3A in which no substantial defects are present within the aircraft component 10, the pulse 24 of ultrasonic energy will propagate through the full thickness (T) of the component 10 before reaching the bottom surface 12 at which point the pulse 24 of ultrasonic energy will be reflected back towards the transducer 26.

When the reflected pulse 24 reaches the transducer 26, the transducer 26 transforms the reflected pulse 24 into an electrical signal which is then subsequently displayed on a display unit 30 so that it can be viewed and interpreted by an operator.

In particular, the display unit 30 displays the amplitude (or strength) A of the detected pulses and also the time (t) at which the pulses 24 were detected.

As shown in FIG. 3A, when no substantial defects are present within the aircraft component 10, the signal displayed on the display unit 30 shows a first peak (PK1) at a first time (t1) which corresponds to the transducer 26 detecting the initial pulse 24 being emitted from the source 22 and a second peak (PK2) at a second time (t2) which corresponds to the transducer 26 detecting the reflected pulse 24 (or echo) as it reaches the transducer 26 having reflected back off the bottom surface 12 of the component 10.

It shall be appreciated that since substantially all of the pulse 24 is reflected off the bottom surface 12 of the aircraft component 10, the amplitude (A2) of the second peak (PK2) should be approximately equal to that of the first peak (PK1) if no defects are present within the aircraft component 10.

It shall also be appreciated that the time gap (G1) between the first (PK1) and second (PK2) peaks should also correspond to the thickness (T) of the aircraft component 10.

Referring now to FIG. 3B, in some instances, the aircraft component 10 may comprise a defect 32. In the case that a defect 32 is present within the thickness of the aircraft component 10, rather than propagating through the full thickness of the aircraft component 10, at least a portion of the pulse 24 will reflect back off the defect 32 towards the transducer 26.

It shall be appreciated that the defect 32 may be an area in which one or more of the composite plies which make up the aircraft component 10 have become delaminated; a foreign object which has been inadvertently captured within the thickness of the aircraft component 10; an area of porosity within the thickness of the aircraft component 10; a crack present within the thickness of the aircraft component 10, and/or another type of defect 32.

As such, in the event that a defect 32 is present within the thickness of the aircraft component 10, the signal displayed on the display unit 30 shows a first peak (PK1) at a first time (t1) which corresponds to the transducer 26 detecting the initial pulse 24 being emitted from the source 22, a second peak (PK2) at a second time (t2) which corresponds to the transducer 26 detecting the reflected pulse 24 (or echo) as it reaches the transducer 26 having reflected back off the bottom surface 12 of the component 10, and also a third peak (PK3) which corresponds to the transducer 26 detecting the reflected pulse 24 as it reaches the transducer 26 having reflected back off the defect 32.

As shown in FIG. 3B, the time (t3) at which the third peak (PK3) is detected by the transducer 26 is typically much sooner than the time (t2) at which the second peak (PK2) is detected since the pulse 24 reflecting off of the defect 32 has a much shorter distance to travel. In other words, the time gap (G2) between the first (PK1) and third peaks (PK3) is shorter than the time gap (G1) between the first (PK1) and second (PK2) peaks.

Furthermore, the respective amplitudes of the second (PK2) and third (PK3) peaks will also typically be less than the amplitude (A1) of the first peak (PK1) when a defect 32 is present within the aircraft component 10.

As such, by analyzing the quantity and associated amplitudes (A) of the respective peaks (PK2 and PK3), and also the times (t) at which the pulses 24 were detected by the transducer 26, an inspector is able to accurately determine whether or not a defect 32 is likely to be present within the aircraft component 10.

Furthermore, in the event that a defect 32 is detected, the inspector can also approximate the depth (D) of the defect 32 within the thickness of the aircraft component 10 based on the ratio between the first (G1) and second (G2) time gaps.

As set out in the Background section above, when performing inspection on an aircraft component 10, the operator will typically follow a pre-approved inspection procedure (or “Scan Plan”) which corresponds to the particular aircraft component 10 undergoing the inspection.

Notably, the pre-approved inspection procedure will typically set out the particular areas of the aircraft component 10 which must be inspected and also the particular NDT techniques and methods which should be utilized when inspecting particular areas of the aircraft component 10.

The aforementioned inspection procedures (or “Scan Plans”) are often provided on physical “technique cards” which must be obtained by the inspector and studied thoroughly prior before the inspection can commence. However, it shall be appreciated that obtaining and studying such “technique cards” prior to each inspection is a very time-consuming process and hence may adversely impact inspection throughput and inspector productivity.

It is also possible that during the inspection of a given aircraft component 10, the inspector may mis-remember or accidentally omit certain aspects of the inspection procedure which may then require the (or another) inspector to re-inspect the aircraft component 10 thereby further increasing the time-burden of the inspection process.

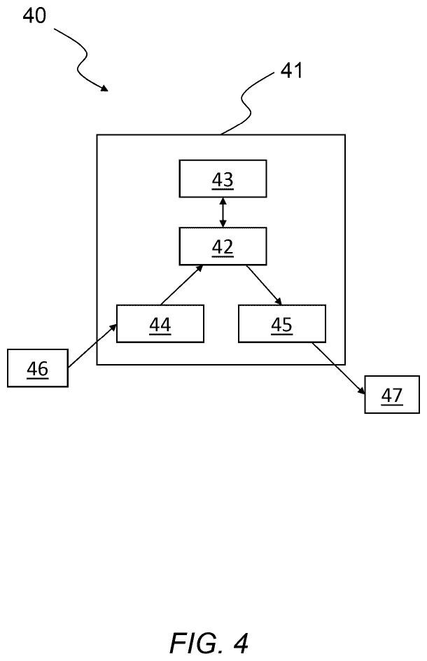

FIG. 4 shows an apparatus 40 for use in a testing procedure on an object, such as a testing procedure on an object using a non-destructive testing apparatus 20 for identifying potential defects as discussed in respect of FIG. 3.

The apparatus 40 as illustrated in FIG. 4 comprises one controller 41, although it will be appreciated that this is merely illustrative. The controller 41 comprises processing means 42 and memory means 43. The processing means 42 may be one or more electronic processing devices 42 which operably execute computer-readable instructions. The memory means 43 may be one or more memory devices. The memory means 43 is electrically coupled to the processing means 42. The memory means 43 is configured to store instructions, and the processing means 42 is configured to access the memory means 130 and execute the instructions stored thereon.

The controller 41 comprises an input means 44 and an output means 45. The input means 44 is configured to receive an image 46 of an object. The output means 45 is configured to output one or more control signals 47.

The input means 44 may be communicatively coupled to a further part of the apparatus 40 or to an external device. The input means 44 may be communicatively coupled to an imaging device, such as a camera, or a scanning device, such as a non-destructive testing apparatus like those discussed above. The input means 44 may be configured to receive an image 46 of an object. The image 46 may be a photographical image (e.g., such as captured by an imaging device) or a scan image (such as captured by a scanning device).

The controller 41 is configured to obtain a reference image of the object. The reference image comprises a representation of the object divided into a plurality of zones; each zone being associated with a respective testing action of the testing procedure. The object may be an aircraft component.

The controller 41 may be configured to obtain the reference image from a plurality of reference images stored in a memory. The plurality of reference images may be stored in the memory means 43 of the apparatus 40 and may be retrieved by the controller 41 or may be stored in a memory of an external device or server and retrieved via the input means 44.

The controller 41 may determine a reference image which corresponds to the object captured in the received image 46. The appropriate reference image may be determined based on a user input (e.g., a selection of a reference image corresponding to the same type of component as the object) or may be determined automatically based on the received image 46. For example, the object captured in the received image 46 may comprise one or more computer-readable identifiers (such as a QR code, a bar code or a serial number), which may be read by the controller 41 (for example using suitable image processing techniques) and which may identify the appropriate reference image.

The reference image may include one or more 2D images of the object or may include a 3D image such as a CAD model of the object.

The reference image may include information relating to a testing procedure associated with the object. For example, the information may include information relating to a testing action associated with each zone of the object. Each zone may be associated with one or more testing actions. The testing actions may comprise one or more non-destructive testing methods such as an ultrasonic A-scan inspection method and/or an ultrasonic C-scan inspection method.

The controller 41 is further configured to output, via the output means 45, a control signal 47 to cause a display unit to display the received image 46 and the reference image.

The display unit may be part of the apparatus 40 or may be an external display unit. The display unit may comprise any suitable display, for example a smart phone display or a personal computer display. In one example, the apparatus 40 may be an augmented reality, AR, or virtual reality, VR, wearable device. In this case, the display unit may be a screen which faces a user's eyes.

The received image 46 and the reference image may be output simultaneously on the display unit. In one example, the received image 46 and the reference image may be overlaid such that a user can see both images simultaneously, and the images may be aligned so that differences between the received image and the reference image are easily identifiable. The received image 46 and the reference image may be aligned via a user input, or via image processing techniques such as the use of reference points in the images, image recognition, and the like.

The controller 41 is further configured to output, on the display unit, an indication. The indication may be a graphical indication (such as coloring, shading, and the like) or may be a text indication. The indication is indicative of whether a testing action has been completed for a zone. For example, the controller 41 may output a first indication indicative of a first testing action associated with a first zone of the object being completed. The indication may be output on the reference image. That is, the display of the reference image may change to indicate that a testing action for a particular zone has been completed (or to indicate that a testing action for the zone is not yet completed).

The controller 41 may output further indications. For example, the controller 41 may control the display unit to display zones for which associated testing actions have been completed differently to zones for which associated testing actions have not been completed.

The controller 41 may further control the display unit to display instructions associated with a testing action for the one or more zones of the object. The instructions may be displayed on the reference image and may indicate a non-destructive testing technique to be used for inspecting the associated zone of the object.

In this way, the user may be assisted in performing the testing procedure, as they may be presented with information indicative of which testing actions have been completed for which zones. The user may thereby be assisted in performing the testing procedure by being better informed as to the actions needed to properly carry out the testing procedure.

The input means 44 may be configured to receive an input signal. The input signal is indicative of a testing action associated with a respective zone of the object being completed. The input signal may be based on a user input (via a user input means of the apparatus 40 or received from an external device). The user input may be an input received from a user indicating that the user has completed the testing action for a particular zone.

Alternatively, or in addition, the apparatus 40 may be communicatively coupled to a scanning apparatus, and the controller 41 may be configured to identify one or more testing actions being completed based on an input signal received from the scanning device. The scanning apparatus may be an NDT apparatus as discussed in respect of FIG. 3 and may transmit measurements to the apparatus 40 or may transmit indications of testing actions being completed.

The input means 44 may further be configured to receive a further input identifying an area of the object requiring re-inspection. The controller 41 may be configured to control the display unit to display a user interface element indicating the area requiring re-inspection in the reference image. The area of the object requiring re-inspection may be identified based on a user's scanning of a zone of the object and may be indicative of a potential defect in the object. For example, each zone of the object may be associated with a known range of measurement values (for example, a signal amplitude or gain value) to be obtained when scanning the object with a scanning device (such as an ultrasound device). If a user or the scanning device observes a measurement outside of an expected range for a particular area, the area may be flagged as having a potential defect. The apparatus 40 can display an indication of any suspicious areas, which can serve as a reminder for the user to re-inspect the area, or can be included in a report of the outcome of the testing procedure. The potential defect may be an area of delamination, a foreign object or piece of debris, an area of porosity and/or a crack.

In some examples, the object may be an aircraft component. Further, the scanning device may comprise an ultrasound or x-ray device. However, the disclosure is not limited thereto, and it should be understood that the apparatus 40 may be suitable for guiding the user in performing other technical processes, such as during the manufacture of aircraft components, or during manufacture, calibration or testing of different physical parts.

The apparatus 40 may further be configured to output a control signal indicative of the testing procedure being complete in response to all testing actions being marked as completed. The controller 41 may be configured to generate a report to certify that all of the testing actions for the respective zones of the object have been completed, and that the testing procedure has been completed. In some embodiments, the controller 41 may also be further configured to prohibit storage of the report until all of the testing actions for the respective zones of the object 53 have been completed.

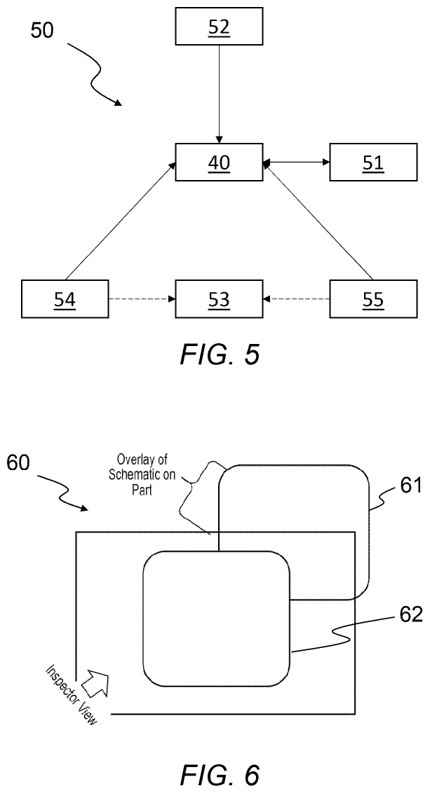

FIG. 5 shows a block diagram illustrating a system 50 according to an embodiment of the invention. The system 50 may be a system 50 suitable for performing a testing procedure, such as a testing procedure using non-destructive testing equipment on aircraft components, as has been discussed before, although it should be understood that the system 50 is not limited thereto.

The system 50 shown in FIG. 5 comprises the apparatus 40 of FIG. 4, a server 51, a user input means 52, an object 53, an imaging device 54 and a scanning device 55. However, as will be explained, the system 50 may not comprise all devices shown in FIG. 5, and one or more of these devices may be omitted. Further, the functions of the system 50 as will be described below may be performed by a distributed system as described or may be performed by fewer integrated devices.

The apparatus 40 may be the apparatus 40 described above in respect of FIG. 4. The apparatus 40 may be communicatively coupled to the user input means 52 and may be configured to receive user inputs as already described in FIG. 4.

The apparatus 40 may further be communicatively coupled to a server 51. The server 51 may be a local or cloud server and may be configured to store the plurality of reference images. The server 51 may further be configured to receive a report from the apparatus 40 indicative of completion of the testing procedure.

The system 50 may optionally comprise an imaging device 54 and/or a scanning device 55. The imaging device 54 may be a camera device and may be configured to capture an image of the object 53 and transmit the captured image to the apparatus 40. The scanning device 55 may be a non-destructive testing apparatus such as the apparatus described in FIG. 3 and may be configured to scan the object 53 and transmit one or more scans of the object 53 to the apparatus 40.

The user input means 52 may be a touch screen, a keyboard and mouse, a microphone for receipt of voice commands, or any other user input means. The user input means 52 may be integrally formed as part of the apparatus 40.

The apparatus 40 may optionally perform the functions of the user input means 52, the server 51, the imaging device 54 and/or the scanning device 55. That is, in some examples, the system 50 may be implemented as a single device, or as fewer devices than shown in FIG. 5.

The apparatus 40 may further comprise a display unit, or the system 50 may further comprise a separate display unit not shown in FIG. 5. Alternatively, or in addition, the imaging device 54, the scanning device 55, the user input means 51 and/or the server 51 may be configured so as to include the display unit for displaying the received image 46 of the object 53 and the associated reference image.

In one example, the apparatus 40 is an AR or a VR wearable device such as a headset and is configured with integrated user input means 52 and/or an integrated imaging device 54. In the case where the apparatus 40 is an AR device, it should be understood that the image of the object may not be displayed, and the reference image may be overlaid over a view of the real object through a transparent display unit.

Further, it should be understood that although certain communication couplings are exemplified in FIG. 5, the various devices of the system 50 of FIG. 5 may communicate with each other differently.

FIGS. 6 to 10 illustrates example user interfaces that may be displayed on the display unit. For example, the user interfaces may be displayed by the apparatus 40 of FIG. 4 or 5, or by an external display unit.

Turning first to FIG. 6, the user interface of FIG. 6 illustrates how a received image 61 of an object and a reference image 62 associated with the object may be simultaneously displayed in one example. In the example of FIG. 6, the received image 61 and the reference image 62 are overlaid. That is, the reference image 62 and the received image 61 may be aligned so as to show substantially the same view of the object. The reference image 62 and the received image 61 may be aligned via user inputs to move one or more of the reference image 62 and the received image 61, or the reference image 62 and the received image 61 may be aligned by the apparatus 40 using image processing techniques.

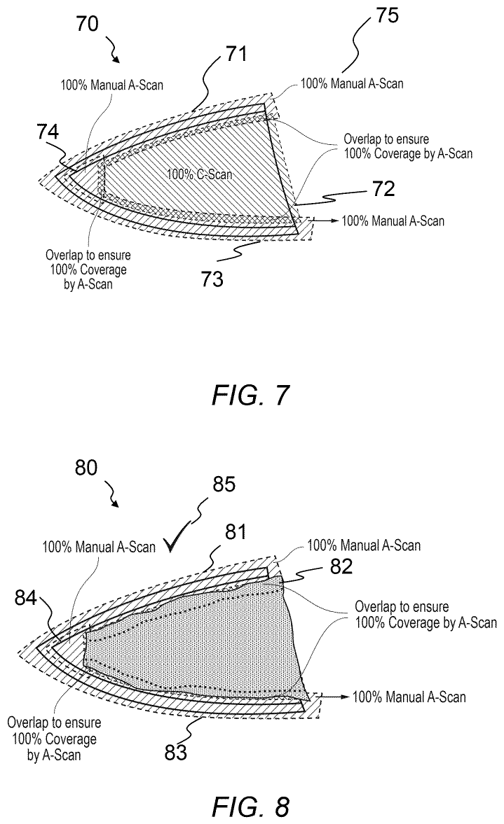

By overlaying the reference image 62 and the received image 61, the user is assisted in performing the testing procedure, because the user may easily compare whether all of the zones of the object have been tested. The user interface 60 may further output additional user interface elements to further assist the user, for example by highlighting whether testing actions for respective zones of the object have been completed or by providing instructions, as will be discussed with respect to FIGS. 7 to 10.

FIG. 7 shows an example user interface 70 in which the reference image 62 and the received image 61 are overlaid such that the user is presented with an overlay of the information included in the reference image aligned with a view of the object 53 in the received image 61.

As shown in FIG. 7, the reference image 62 may include information relating to a plurality of zones 71, 72, 73, 74 of the object 53, each zone being associated with one or more testing actions of the testing procedure. As discussed above, the testing actions may relate to particular scanning techniques. In the example of FIG. 7, the reference image of the object comprises a first zone 71, a second zone 72, a third zone 73 and a fourth zone 74.

Each of the zones 71, 72, 73, 74 may be illustrated by a graphical element, such as a dotted line bordering the zone, which may have shading distinguishing a zone from an adjacent zone, although the disclosure is not limited thereto. Each of the zones 71, 72, 73, 74 may be associated with an area of the object 53 and optionally with a testing action. The testing action may be indicated on the user interface 70, although it should be understood that this is optional. In the example of FIG. 7, the user interface 70 comprises information relating to a testing action associated with each of the zones 71, 72, 73, 74. For example, a first testing action 75 associated with the first zone 71 is indicated as “100% Manual A-Scan” which informs the user as to the required type of scanning operation and the coverage of the zone which is required for the testing action to be considered complete. It should be understood that the testing actions may be represented in the user interface 70 in a number of ways. Although in FIG. 7 the testing actions are represented in text form, it should be understood that the disclosure is not limited thereto, and for example various graphical icons may instead be used. Further, the testing actions associated with each of the zones 71, 72, 73, 74 may not always be simultaneously displayed, but a testing action associated with a zone may be selectively displayed in response to a user input or in dependence on whether the testing action for the zone is already completed or not.

As shown in FIG. 7, in some cases there may be an overlap between adjacent zones 71, 72, 73, 74 indicating that the user is to scan the object 53 such that some overlap between different zones is achieved. The overlap may prevent areas of the object 53 from being missed by the inspector by providing redundancy. It should be understood that adjacent zones may overlap by any distance, but in one example, adjacent zones are configured to overlap by a distance of approximately 5 mm.

FIG. 8 illustrates another user interface 80. The user interface 80 of FIG. 8 is similar to the user interface 70 of FIG. 7, but in the user interface 80 of FIG. 8, a testing action associated with the second zone 82 has been completed. In this case, the display is updated to indicate that the testing action associated with the second zone 82 is complete. In the example of FIG. 8, the indication relating to the second zone 82 takes the form of coloring or shading of the second zone 82, but it should be understood that the disclosure is not limited thereto.

As explained above, when a testing action for a zone is completed, the display may cease displaying information or instructions associated with the completed zone.

Alternatively, or in addition, when a testing action associated with a zone is completed, the user interface 80 may comprise an indication 85 indicating that the testing action is completed. For example, if the Manual A-Scan associated with the fourth zone 84 is completed, a tick mark may be displayed as an indication 85 that this testing action has been completed.

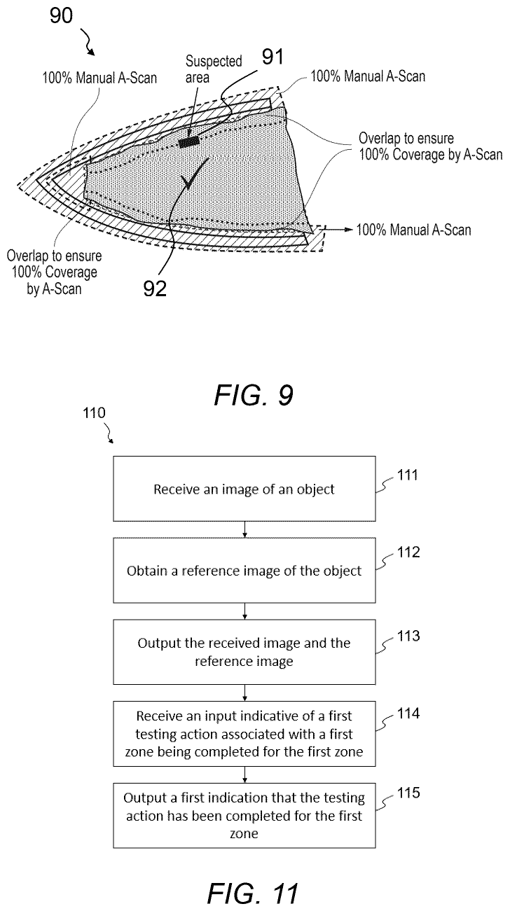

FIG. 9 illustrates another user interface 90. The user interface 90 is similar to the user interfaces 70, 80 of FIGS. 7 and 8. The user interface 90 additionally shows a graphical representation of an area 91 which has been flagged as suspicious or requiring re-inspection. The area 91 may be flagged by a user input or based on measurements received from a connected scanning device. The area 91 may be indicative of a suspected potential defect in the object 53 and may serve as a reminder to the user to re-inspect the area 91 or to include information relating to the area 91 in a report of the testing procedure.

The user interface 90 also shows a further example of an indication 92 associated with a testing operation associated with the second zone being completed. In this example, the second zone is displayed with a different color to the other zones, and an additional indication 92 is displayed overlaying the second zone.

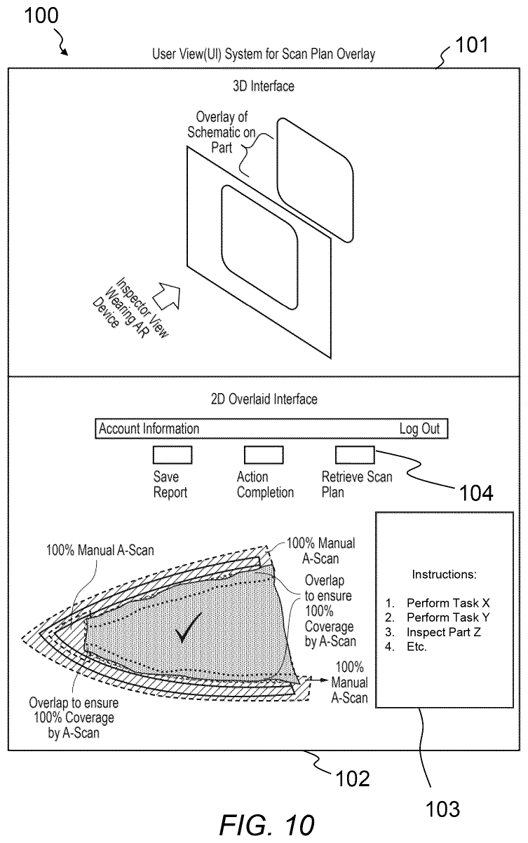

FIG. 10 illustrates further example user interfaces 100. A first user interface 101 illustrated in FIG. 10 shows how a 3D overlay interface may be presented to a user, in which a reference image is overlaid over the captured image of the object 53.

A second user interface 102 illustrates how a 2D overlay interface, such as those shown in FIGS. 7 to 9, may be displayed. In addition to the display of the zones of the object 53 as previously discussed, the second user interface 102 also shows how instruction interface elements 103 and control interface elements 104 may be displayed. The instruction interface elements 103 may comprise instructions for performing the scanning operation and may be displayed simultaneously with the reference image. The control interface elements 104 may include user selectable buttons for controlling the apparatus 40, and for example may include selectable buttons to save progress, mark a zone or associated testing action as complete, to end the process, to retrieve a reference image, or to manage user profiles and the like. It should be understood that the disclosure is not limited thereto, and other control elements may be provided.

The user interfaces illustrated in FIGS. 6 to 10 should be understood as examples only, and it should be understood that the presentation of the received image of the object and the reference image associated with the object may vary.

FIG. 11 illustrates a method 110 for performing a testing procedure on an object 53. The method 110 may be performed by the apparatus 40 of FIG. 4 or the system 50 of FIG. 5.

The method 110 includes receiving 111 an image of an object. The image of the object may be received from an imaging device (such as a camera) and/or a scanning device (such as an ultrasound scanner). The object may be an aircraft component.

The method 110 includes obtaining 112 a reference image associated with the object. The reference image includes a representation of the object divided into a plurality of zones, each zone being associated with a respective testing action of the testing procedure. The testing action may include one or more scanning or testing techniques for examining the object, and an area to be scanned.

The reference image may be obtained in various ways as described above. For example, the reference image may be obtained from a storage device storing a plurality of reference images corresponding to a plurality of objects. The reference image associated with the imaged object may be selected based on a user input or based on an identifier of the object identifiable in the received image. The identifier may be a QR code or a bar code, or the like. The reference image may also be obtained by performing object recognition on the received image and identifying a type of the object in the received image.

The method 110 further includes outputting 113 the received image and the reference image on a display unit. The received image and the reference image may be displayed simultaneously. The received image and the reference image may be overlaid such that the user is able to view both the received image and the reference image simultaneously. The received image and the reference image may be aligned such that the representation of the object in the reference image lines up with the image in the received image. The received image and the reference image may be aligned via user input, or by a processor using image recognition or image processing techniques.

The method 110 further includes receiving 114 an input indicative of a first testing action associated with a first zone being completed for the first zone. The input may be a user input. For example, a user may interact with an input means of the apparatus 40 and make an input confirming that they have completed the first testing action. The method 110 further includes outputting 115, on the display unit, a first indication that the first testing action has been completed for the first zone. As previously discussed, the indication that the first testing action has been completed may take a variety of forms. In one example, the zones in the reference image are visibly identifiable by means of a graphical border surrounding the zones, and the indication that the first testing action has been completed may comprise coloring or shading the first zone in a color different to zones for which associated testing actions have not yet been completed. Alternatively, or in addition, a graphical user interface element (GUI) such as a tick may be displayed to indicate that the first testing action has been completed.

The method 110 may further comprise other steps, for example based on the functions of the apparatus 40 of FIG. 4 or the system 50 of FIG. 5 described above. For example, the method 110 may further comprise displaying instructions associated with one or more testing actions, receiving an input identifying an area requiring re-inspection, displaying a GUI indicating that the area requires re-inspection, outputting a certification that the testing procedure has been completed, and/or highlighting zones for which associated testing actions have not been completed.

The systems and devices described herein may include a controller or a computing device comprising a processing unit and a memory which has stored therein computer-executable instructions for implementing the processes described herein. The processing unit may comprise any suitable devices configured to cause a series of steps to be performed so as to implement the method such that instructions, when executed by the computing device or other programmable apparatus, may cause the functions/acts/steps specified in the methods described herein to be executed. The processing unit may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory may be any suitable known or other machine-readable storage medium. The memory may comprise non-transitory computer readable storage medium such as, for example, but not limited to, an electronic, magnetic, optical, electromagnetic, infrared, or semiconductor system, apparatus, or device, or any suitable combination of the foregoing. The memory may include a suitable combination of any type of computer memory that is located either internally or externally to the device such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. The memory may comprise any storage means (e.g., devices) suitable for retrievably storing the computer-executable instructions executable by processing unit.

The methods and systems described herein may be implemented in a high-level procedural or object-oriented programming or scripting language, or a combination thereof, to communicate with or assist in the operation of the controller or computing device. Alternatively, the methods and systems described herein may be implemented in assembly or machine language. The language may be a compiled or interpreted language. Program code for implementing the methods and systems described herein may be stored on the storage media or the device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein.

Computer-executable instructions may be in many forms, including modules, executed by one or more computers or other devices. Generally, modules include routines, programs, objects, components, data structures, etc., that perform particular tasks or implement particular abstract data types. Typically, the functionality of the modules may be combined or distributed as desired in various embodiments.

It will be appreciated that the systems and devices and components thereof may utilize communication through any of various network protocols such as TCP/IP, Ethernet, FTP, HTTP and the like, and/or through various wireless communication technologies such as GSM, CDMA, Wi-Fi, and WiMAX, is and the various computing devices described herein may be configured to communicate using any of these network protocols or technologies.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

Where the word ‘or’ appears this is to be construed to mean ‘and/or’ such that items referred to are not necessarily mutually exclusive and may be used in any appropriate combination.

Although the invention has been described above with reference to one or more preferred embodiments, it will be appreciated that various changes or modifications may be made without departing from the scope of the invention as defined in the appended claims.

Claimed is:

1. An apparatus for use in a testing procedure on an object, the apparatus comprising:
one or more processors configured to:
receive an image of the object;
obtain a reference image associated with the object, the reference image including a representation of the object divided into a plurality of zones, each zone associated with a respective testing action of the testing procedure;
simultaneously output the image and the reference image on a display unit;
receive an input indicative of a first testing action associated with a first zone being completed; and
output, on the display unit, a first indication that the first testing action has been completed for the first zone.

2. The apparatus according to claim 1, wherein the one or more processors are further configured to output, on the display unit, a second indication indicative of a respective second testing procedure not being completed for a second zone.

3. The apparatus according to claim 2, wherein the first indication and the second indication are graphically different, or
wherein the first indication comprises coloring the first zone in a first color and the second indication comprising coloring the second zone in a second color, or
both.

4. The apparatus according to claim 1, wherein the first indication is displayed on the reference image.

5. The apparatus according to claim 1, wherein the one or more processors are further configured to:
receive a further input identifying an area, of the object, requiring re-inspection; and
output, on the display unit, a user interface element indicating the area requiring re-inspection in the reference image.

6. The apparatus according to claim 1, wherein the reference image comprises instructions for testing each zone of the object.

7. The apparatus according to claim 6, wherein the instructions for testing each zone of the object comprise a scanning technique to be used to test each zone of the object.

8. The apparatus according to claim 1, wherein the one or more processors are further configured to overlay the reference image over the image.

9. The apparatus according to claim 8, wherein the one or more processors are further configured to align the reference image over the image using image processing.

10. The apparatus according to claim 1, wherein the one or more processors are further configured to obtain the reference image from a memory of the apparatus or from an external server storing a plurality of reference images associated with a respective plurality of objects, or
wherein the one or more processors are further configured to obtain the reference image based on one or more of: a user input selecting the reference image from the plurality of stored reference images; an identifier of the object detected in the image; or performing object recognition on the image and identifying a type of the object in the image, or
wherein the reference image comprises one or more 2D images of the object or a 3D image of the object, or
any combination thereof.

11. The apparatus according to claim 1, wherein the apparatus is communicatively coupled to an imaging device configured to capture the image of the object, and
wherein the image of the object is received from the imaging device.

12. The apparatus according to claim 1, further comprising:
a virtual reality, VR, or augmented reality, AR, wearable device.

13. The apparatus according to claim 1, wherein the first zone of the object partially overlaps with a second zone of the object.

14. The apparatus according to claim 1, wherein the one or more processors are further configured to generate a report to certify that all of the testing actions for the respective zones of the object have been completed, and that the testing procedure has been completed.

15. The apparatus according to claim 14, wherein the one or more processors are further configured to prohibit storage of the report until all of the testing actions for the respective zones of the object have been completed.

16. The apparatus according to claim 1, wherein the testing action comprises a non-destructive inspection technique, or
wherein the testing action comprises a non-destructive inspection technique and the non-destructive inspection technique is an ultrasonic inspection technique, or
wherein the testing action comprises a non-destructive inspection technique and the non-destructive inspection technique is an ultrasonic A-scan inspection technique, an ultrasonic C-scan inspection technique, or an combination thereof.

17. A method for performing a testing procedure on an object, the method comprising:
receiving an image of the object;
obtaining a reference image associated with the object, the reference image including a representation of the object divided into a plurality of zones, each zone being associated with a respective testing action of the testing procedure;
simultaneously outputting the image and the reference image on a display unit;
receiving an input indicative of a first testing action associated with a first zone being completed; and
outputting, on the display unit, a first indication that the testing action has been completed for the first zone.

18. The method according to claim 17, wherein the object is an aircraft component.

19. A method for inspecting an aircraft component comprising the steps of:
identifying an aircraft component to be inspected;
retrieving an inspection plan corresponding to the aircraft component from a plurality of inspection plans, wherein each inspection plan is associated with a corresponding aircraft component, and wherein each inspection plan comprises one or more inspection actions to be performed on an associated aircraft component;
capturing an image of the aircraft component to be inspected;
displaying the image of the aircraft component on a display unit, wherein the inspection plan is overlaid onto the image;
receiving an input indicative of one or more regions of the aircraft component having been inspected in accordance with the inspection plan displayed on the display unit; and
updating a display of the image or the inspection plan in response to the input.
